(19) United States
(12) Patent Application Publication
(10) Pub. No.: US 2010/0076886 A1
(43) Pub. Date: Mar. 25, 2010

(54) Trading Platform

(75) Inventors: Ross Alexander Adams, Queens Park (AU); Andrew William Dihm, Chifley (AU); Steven Edwin Tomlin, Matraville (AU)

Correspondence Address: Sunstein Kann Murphy & Timbers LLP, 125 SUMMER STREET, BOSTON, MA, 02110-1618, US

(73) Assignee: INNOVATE TECHNOLOGIES PTY LTD, Sydney (AU)

(21) Appl. No.: 12/578,817

(22) Filed: Oct. 14, 2009

Related U.S. Application Data
(63) Continuation-in-part of application No. PCT/AU2008/000526, filed on Apr. 14, 2008.

(30) Foreign Application Priority Data
Apr. 19, 2007 (AU) 2007902062

(51) Int. Cl. G06Q 40/00

(52) U.S. Cl. 705/37

(57) ABSTRACT

This invention concerns a trading platform suitable for derivative and foreign exchange transactions between wholesale banking clients operating in the global financial markets. In particular, the invention concerns an interactive, automated computerized trading platform for regulating the buying and selling of all or part of orders listed on the platform by traders. Using the platform a trader (a broker or dealer) is able to enter an order that includes a (offer or bid) price visible to counterparties as well as one or more better prices that are hidden from counterparties. The trader is also able to interactively respond to visible (bid or offer) prices in counterparties' orders by changing the prices in their own order. And, the platform responds automatically to a counterparty's order that includes a visible price which matches a price, whether visible or hidden, in the trader's order, to facilitate a trade between them. In another aspect the invention concerns a method of operating an interactive, automated computerized trading platform. In a further aspect the invention concerns a computer program product.

### CROSS REFERENCE TO RELATED APPLICATIONS

This application is a continuation-in-part of International Application PCT/AU2008/000526, with an international filing date of Apr. 14, 2008 and published as number WO 2008/128277 A1, which is hereby incorporated herein by reference. The foregoing International Application claims priority based on Australian application 2007902062, filed Apr. 19, 2007.

### TECHNICAL FIELD

This invention concerns an interactive, automated computerized trading platform, suitable for use in any tradeable market, for instance derivative and foreign exchange transactions between wholesale banking clients operating in the global financial markets. In other aspects, the invention concerns a method of operating the trading platform and a computer program product.

### BACKGROUND ART

On-line trading platforms have become available to facilitate derivative and foreign exchange transactions between banking clients in over the counter (OTC) financial markets and for Exchange Traded Contracts (ETC). These platforms display the best Buy and Sell prices of all listed orders to all authorized participants. Typically in markets with high liquidity the prices on the buy side and sell side of the market will be only a single increment apart. When a Buy and Sell price match, a trade may then be consummated for all or part of the matching orders. The precise way in which the trade is finalized may depend on the rules of the market and detail of the orders.

### SUMMARY OF THE INVENTION

In a first aspect, the invention is an interactive, automated computerized trading platform for regulating the buying and selling of all or part of orders listed on the platform by traders, for instance brokers or dealers. Using the platform a trader (a broker or dealer) is able to enter an order that includes a (offer or bid) public price that is visible to counterparties as well as one or more better secret prices that are hidden from counterparties. The trader is also able to interactively respond to public (bid or offer) prices in counterparties' orders by changing the prices in their own order. And, the platform responds automatically to a counterparty's order that includes a visible price which matches a price, whether public or secret, in the trader's order, to facilitate a trade between them.

This invention has the potential to revolutionize screen trading in all existing electronic markets and to create new electronic transaction marketplaces in areas where electronic solutions have either failed or have not been attempted. This is because the invention, for the first time, allows electronic trading systems to emulate the subtleties of existing trading techniques.

The platform may automatically operate to notify either or both parties in the event that a counterparty's order is placed containing a public price that matches either a public or secret price of an existing order.

Notification functionality may also be enabled by one of the parties specifying a notification price in a non-firm order (a notification order), and the alert may be triggered in the event that a counterparty's order is placed containing a public price that matches or overlaps the notification price. The functionality can be used by a trader to firm an order (Hidden or Visible) when a counterparty posts an order a predetermined number of increments from the notification order.

The platform may allow a trader to issue a hidden order containing only a secret price, and no public price. No publicly available record is kept of this type of order if no subsequent trade takes place.

A secret price may automatically be cancelled or converted into a notification price, leaving the rest of the order intact, when a predetermined event occurs.

Traders who enter an order with a secret price may see on their trading screen, by default, their best secret prices. This is so the trader is always aware of the best price they are offering. Orders that contain a secret price may appear in a different format to highlight that the order has a secret price. For example, the order may appear in a different font or have a box around it.

A trader may toggle his/her screen to temporarily display his/her visible order prices rather than the best hidden prices. Other parties only ever see the public prices.

If multiple orders are placed on the same side at the same price, the platform may apply rules to determine which order is presented to the counterparty first. For example, the platform may give priority to a public price over a secret price even when the secret price was entered first.

In the event of two orders, on different sides, having overlapping prices, whether a public price in one order overlaps a public or secret price in the other order, the differential can be attributed in a manner determined by the platform. For example, the order that was entered first could get all the benefit of the overlap, or the benefit could be shared between both of the orders.

In a second aspect, the invention is a method of operating an interactive, automated computerized trading platform that regulates the buying and selling of all or part of orders listed on the platform by traders.

In a further aspect the invention is a computer program product for operating an interactive, automated computerized trading platform that regulates the buying and selling of all or part of orders listed on the platform by traders, the computer program product comprising a computer readable medium having computer readable program code stored thereon, the computer readable program code comprising program code for performing the method.

### BRIEF DESCRIPTION OF THE DRAWINGS

An example of the invention will now be described with reference to the accompanying drawings, in which:

FIG. 1 is a block diagram of an interactive, automated computerized trading platform.

FIG. 2 is a screenshot of an inputting dealer's screen view;

FIG. 3 is a screenshot of a counterparty's screen view;

FIG. 4 is a screenshot of an order input and management wizard;

FIG. 5 is a flowchart of a exemplary method of operating the trading platform; and

FIG. 6 is a flowchart of continuing from FIG. 5.

### DETAILED DESCRIPTION OF SPECIFIC EMBODIMENTS

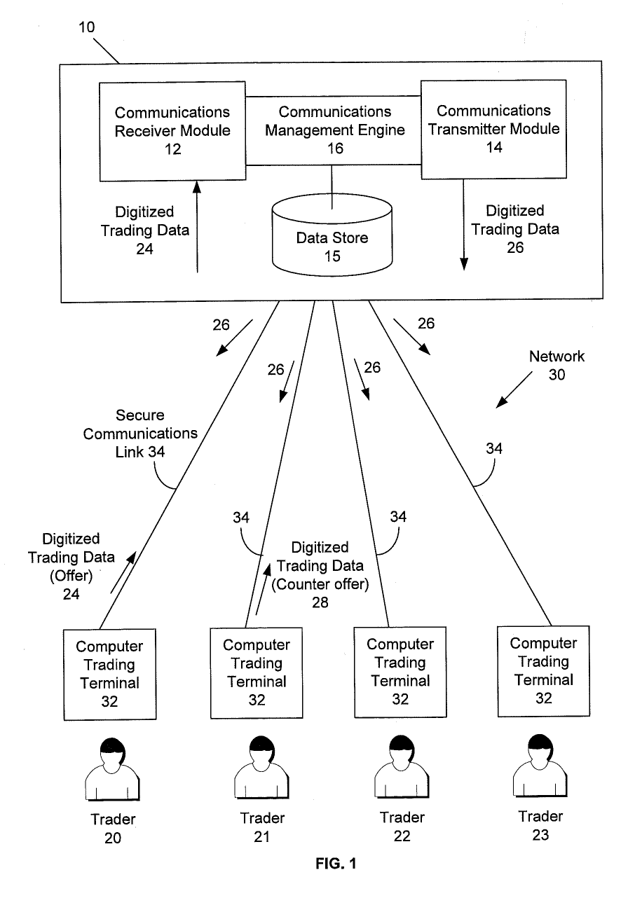

Referring first to FIG. 1, an interactive, automated computerized trading platform 10, comprises a communications receiver module 12, a communications transmitter module 14 and a communications management engine 16 to interface between the receiver module 12 and transmitter module 14. The communications management engine 16 is also operable to store and retrieve data from a data store 15, either via a local area network or a wide area network in the form of the Internet (not shown).

The platform 10 regulates the buying and selling of all or part of product orders listed on the platform between remote counterparty traders, such as 20 and 21, one of whom is selling while the other is buying. The platform 10 includes all the usual facilities and functionality of a market platform, such as managing trader accounts, complying with regulatory oversight, making and receiving payments, and managing the integrity and security of the distributed trading environment it serves.

The communications receiver module 12 receives digitized trading data 24 transmitted from any one of a network 30 of interactive computer trading terminals 32 via respective secure communications links 34.

The communications transmitter module 14 transmits the digitized trading data 26 to all the interactive computer trading terminals 32 via the secure communications links 34. At the trading terminals 32 the digitized trading data is posted so that the traders 20, 21, 22 and 23 are able to view the trading data 26 in real time on their terminal's screens.

The trading platform 10 and terminals 32 necessarily includes all the other computer equipment and peripherals, usually associated with secure trading networks; as well as the security requirements customary for trading systems where the traders are remote from the platform 10.

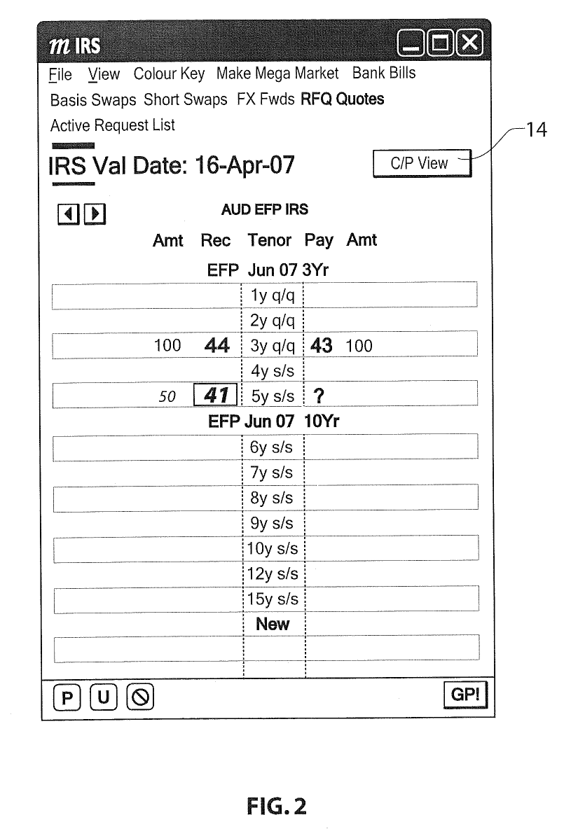

FIG. 2 illustrates how digitized trading data is entered by the traders, and how it appears. In general the screen of a terminal 32 shows a list of tradable products together with their tenor. If any of the commodities are being offered for sale or are under offer to buy, the price and amount of the order are posted and shown; the sale price is shown on the left and the buy price on the right hand side of the screen. In this case a 100 units of the 3y q/q has been offered by a seller for sale at price ‘44’, and a buyer has offered price ‘43’ for the entire 100 on offer.

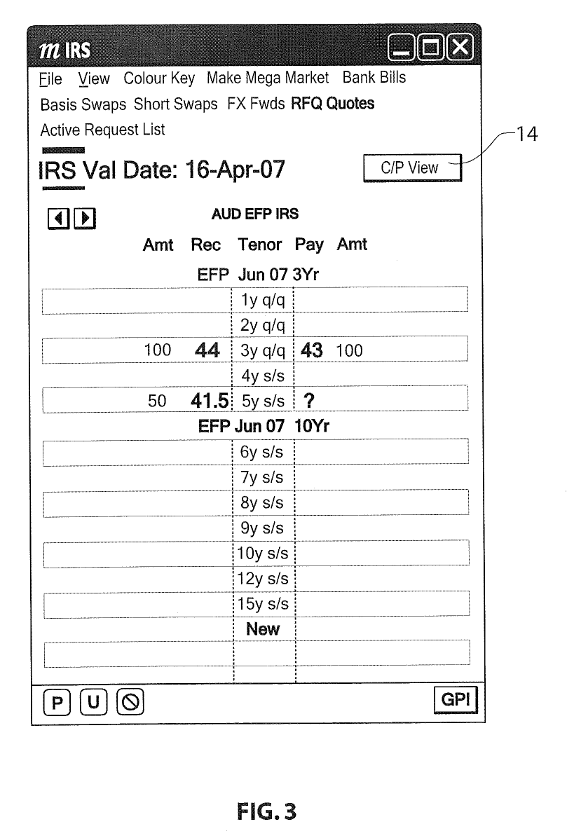

In response to the information on the screens in front of them at their terminals 32, the traders 20, 21, 22 and 23 selectively enter further digitized trading data for transmission to the trading platform 10 using the respective secure communications link 34. The screens of terminals 32 are generally touch sensitive and the traders enter prices and amounts by clicking on the screen in either the sell or buy side; in FIGS. 2 and 3 these are labeled ‘Rec’ and ‘Pay’.

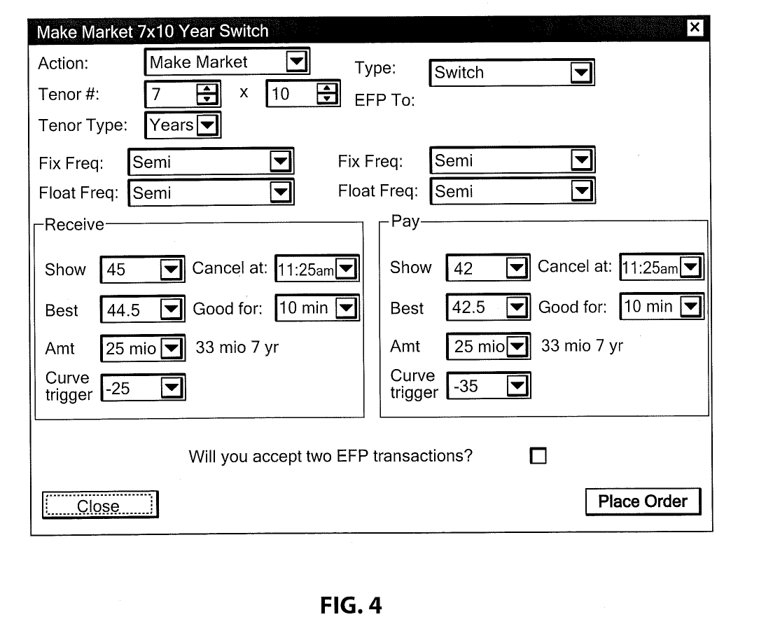

The traders 20, 21, 22 and 23 can also enter prices and amounts by clicking in the product description center column, will initiate the display of the two way Order Input Wizard shown in FIG. 4. The two way wizard allows both a buy and sell level to be entered. Clicking just on the buy or sell would show one set of inputs.

The labels used for the data entry boxes in FIG. 4 will now be explained

‘Show’ is the public price that will be posted to other traders on their screens.

‘Best’ is the secret price, that is better than the public price, and is not posted to other traders. There may be multiple secret prices and their respective Best levels depending on Market demands. For example, labels Best 1 and Best 2 can each represent a secret price.

‘Cancel at’ sets a time at which an order is either cancelled or a notice of impending cancellation is activated. This can be either actual time or time to cancel.

‘Good for’ sets the length of time a secret price stays firm for before it is cancelled, or referred.

‘Trigger’ is a level, criteria or event that if traded or occurs would cause the trader to want to reexamine an order. This may set some form of notification or cancel the order. Curve trigger in this instance is particular to the Interest Rate market.

The ‘Good for’ feature allows an order to be referred to a trader for reconfirmation of their intention to trade at this secret price before committing to the deal. This serves as a protective feature that provides comfort to conservative traders in various styles of market by increasing their confidence to place more orders and efficiency of not having to constantly check screen movements.

The trader 20 who operates the screen shown in FIG. 2 has also offered 50 of the 5y s/s for sale at price ‘41’ that is being is kept secret. This price is visible only to trader 20 and not to any other traders 21, 22, 23 communicating with the platform 10. The public price ‘41.5’ which is visible to other traders is shown in FIG. 3.

The trader 20 enters this trading data 24 and it is then automatically encrypted by the terminal 32 and sent to the trading platform 10 over the secure communications link 34.

At any time, the trader 20 may view the public price posted to counterparties by depressing and holding down “C/P View” button 14, and this screen is seen in FIG. 3. This facility allows the dealer to be certain about the information revealed to counterparties.

A trader's own prices are generally color coded and shown in blue font to identify ownership, whereas counterparty's prices are shown in black font. The box around a price indicates it to be hidden and italics denotes that the price has been referred

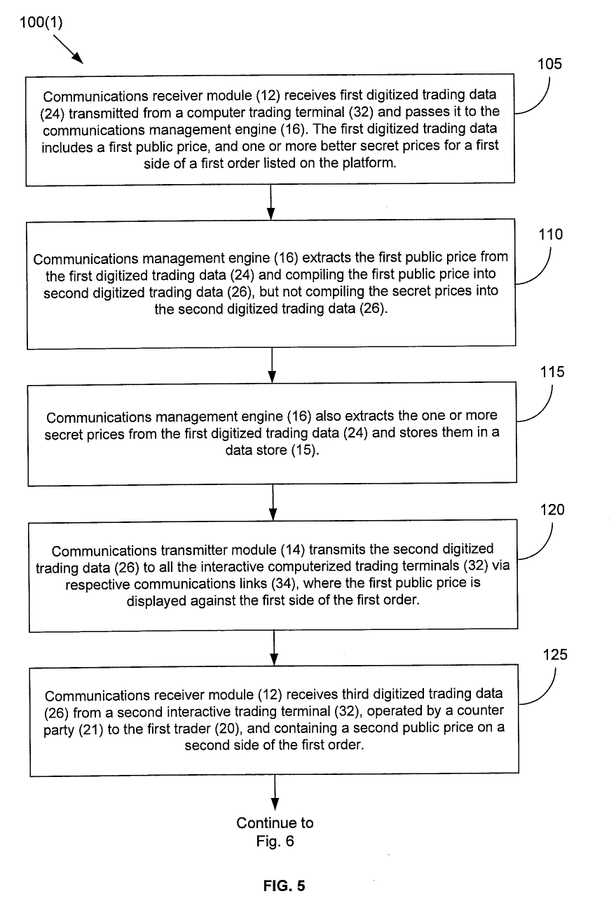

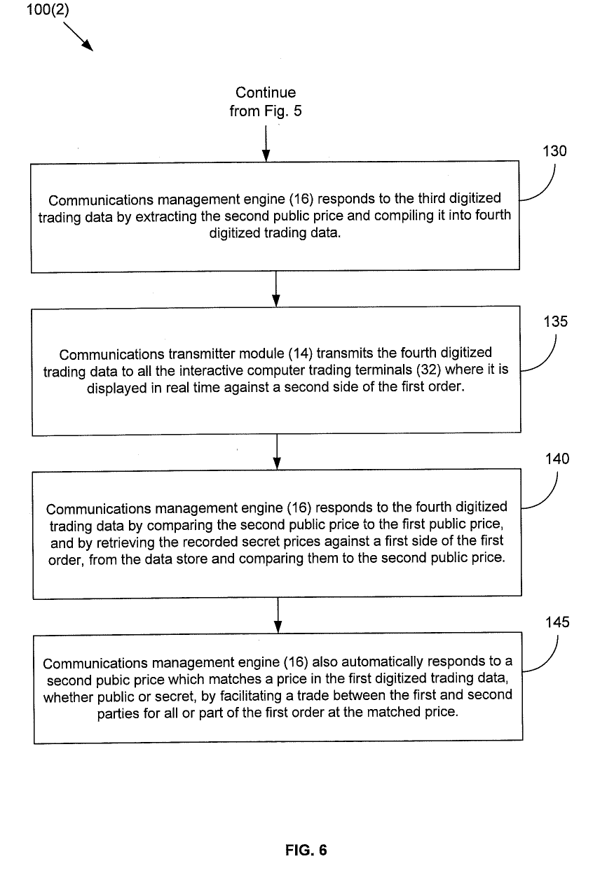

Referring also to the flowcharts in FIGS. 5 and 6, the steps performed by the communications receiver module 12, communications transmitter module 14 and communications management engine 16 of the trading platform 10 will now be explained using the example shown in FIGS. 2 and 3.

At trading platform 10 the communications receiver module 12 receives a first digitized trading data 24 from the first trader 20 and passes it to the communications management engine 16; see step 105 in FIG. 5. In this case, the first digitized trading data 24 includes a public price (i.e. ‘41.5’) and one better secret price (i.e. ‘41’) for the sell side of the order (i.e. 50 units of 5y s/s).

The communications management engine 16 responds to receiving the first digitized trading data 24, by extracting or processing it to recognize the public price ‘41.5’ and compiling it into a second digitized trading data; see step 110 in FIG. 5. The second digitized trading data is then passed to the communications transmitter module 14.

The communications management engine 16 also extracts the secret price ‘41’ (there could be more than one of them) from the first digitized trading data 24 and records the extracted secret price in the data store 15; see step 115 in FIG. 5. However, the communications management engine 16 does not pass the secret price to the communications transmitter module 14 for dissipation over the network 30; so that the secret price is not posted and revealed to other traders 21, 22, 23.

Next, communications transmitter module 14 transmits the second digitized trading data 26 compiled by the communications management engine 16, now containing the public price ‘41.5’, to all the interactive computer trading terminals 32 via respective secure communications links 34; see step 120 in FIG. 5.

At the trading terminals 32, the public price ‘41.5’ is extracted from the second digitized trading data 26 and displayed on screens of the trading terminals 32 as shown in FIG. 3. Here it is visible to all the traders 21, 22, 23 against the order to sell 50 5y s/s. The question mark ‘?’ displayed against the buy side of the order indicates that no counter offer, or no counter offer with a public price, has yet been submitted against the order.

Any other trader 21 is able to respond to the displayed public price ‘41.5’ by entering a counter offer, containing a public price and one or more secret prices against the buy side of the order, that is returned to platform 10. The counter offer (third digitized data 28) is then automatically encrypted by the terminal 32 operated by trader 21, and sent to the trading platform 10 over the secure communications link 34.

At the platform 10, communications receiver module 12 receives the counter offer or third digitized trading data 28 containing the public and one or more secret prices; see step 125 in FIG. 5.

In response to the third digitized trading data 28, communications management engine 16 automatically extracts and passes the public price of the counter offer and compiling it into a fourth digitized trading data containing only the public price; see step 130 in FIG. 6.

The communications management engine 16 then passes the fourth digitized trading data to the communications transmitter module 14 for transmission to all the interactive computer trading terminals 32 where it is displayed in real time against the buy side of order 50 5y s/s; see step 135 in FIG. 6.

The communications management engine 16 also automatically responds by comparing the public price of the counter offer from counterparty trader 21 with the prices, both public and secret, in the first digitized trading data from trader 20; see step 140 in FIG. 6. In the event a public price is received from counterparty trader 21 that matches an existing posted public price or a recorded secret price, then the communications management engine 16 matches those prices.

In the example of FIGS. 2 and 3, receipt of a public price of ‘41’ offered by counterparty trader 21 for 50 or less of the 5y s/s will be matched against the secret price of ‘41’ recorded by the communications management engine 16 for the first trader 20.

When a match is found, the communications management engine 16 facilitates a trade between the traders 20, 21 by automatically notifying the first trader 20 and counterparty trader 21 of the match; see step 145 in FIG. 6. This can be achieved by means of digitized messages transmitted over respective communications link 34, such as in the form of an email, or an audio or visual alert.

The first trader 20 is then able to interactively respond to the public prices of any counter offer being entered against the listed order. For instance the first trader's response may be to enter changed digitized trading data, where one of the prices in the first digitized trading data 24 is changed.

### Notification Orders

As explained with reference to FIG. 4, the trading platform 10 also provides a notification functionality where one of the parties can specify a notification price in a non-firm order. In this case, the communications receiver module receives a notification price from a third trader 22 and automatically passes it to the communications management engine 16. When a counterparty trader's public price matches or overlaps the notification price, the communications management engine 16 responds automatically by notifying the third trader 22 of the match or overlap.

However, unlike for a public price, the communications management engine 16 does not pass the notification price to the communications transmitter module 14 for dissipation over the network 30. The notification price can be set at a predetermined difference from a secret price previously specified by the third trader 22.

### Hidden Orders

A hidden order can also be made with only a secret price, and no public price. In this case, upon receiving a secret price for a listed order on the platform, such as from a trading terminal 32 operated by fourth trader 23, the communications management engine 16 does not pass the secret price to the communications transmitter, even though the fourth trader 23 has no public price against the order.

The communications management engine 16 may automatically either cancel a secret price, or converts a secret price into a notification price, leaving the rest of the digitized trading data intact, when a predetermined event occurs. For example, after the expiry of a predetermined time period after the secret price was first offered, or because the price of a particular instrument known to the system moves (or doesn't move in a certain time period). In this case, the communications management engine 16 sends an alert to the communications transmitter module for transmission to the trader.

Secret prices may be firm for a described default time and then are referred dependant on when they were entered and if they have been changed by the dealer.

### Matching Rules

In the event the communications receiver module 12 receives more than one price for the same order, on the same side (e.g. buy) and in the same amount, the communications engine 16 applies rules stored in the data store 15 to determine which price is passed to the communications transmitter module 14 for transmission to the counterparty first.

### The Rules Include the Following

Firm visible orders having a public price have priority over any secret price at the same trading price, even when the secret price was entered first. For example, a public price entered by trader 21 will have priority over a secret price by the fourth trader 23, even when the latter was entered first.

### Firm Secret Orders have Trading Priority over Referred Orders at the Same Price

There is no queue for non-firm (notification) orders, as all such orders at the same price will be invited to deal and the first to respond by firming the order will be given the opportunity to deal first.

The status of all orders, public or secret, initiated will be either firm or referred or a combination of both. These orders status can be governed by one or a combination of criteria which may be defaulted by the system administrator or by the traders themselves.

Traders are asked by way of active notifications that allow them to trade, cancel order or adjust their order level at the previously described default levels.

Traders may also be able to set how many increments, if any, from their secret order they are asked to reconfirm their order levels.

Apposing Firm status orders at the same level directly deal.

Apposing referred status order and firm status order will result in the referred trader being asked if they can trade at the level before dealing takes place.

Both owners of apposing referred status orders at the same level will be asked if they are prepared to deal before dealing takes place.

A hit at the level of a visible referred order will result in the referred trader being asked to trade at the level and the hitter having the option to call off the attempted trade at any time prior to the hit dealer accepting the hit level. A hitter always has firm status at the level.

Similarly in the event the communications receiver module 12 receives two prices on different sides (buy and sell) of the same order, at least one of which prices is public, and the two prices overlap without matching, then communications management engine 16 applies rules retrieved from a data store 15 to determine how the overlap is resolved. The resolved price is then passed to the communications transmitter module 14 for transmission to the counterparty.

Then the communications management engine 16 also facilitates a trade between the two counterparties 20 and 21 according to the trading exchanges rules for consummating transactions. For instance, the particular order, including the amount or quantity of the trade covered by the match price, may be frozen for a period of time while the counterparties finalize sale documentation.

### INDUSTRIAL APPLICABILITY

This invention may find application in any of the following:
All screen based trading systems
All exchange traded futures
Energy
Commodities
Weather
Carbon
Water
Property
Bonds
Bank Bills
Deposits
Foreign Exchange
Repurchase Agreements
Equities
Credit
Securities Mortgages
Freight
Precious Metals
Base Metals
Oil
Coal
Electricity
Natural Gas
Emissions

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

What is claimed is:

1. An interactive, automated computerized trading platform for regulating the buying and selling of all or part of orders listed on the platform by traders, the platform comprising:
a communications receiver module that receives digitized trading data transmitted from any one of a network of interactive computer trading terminals that are coupled with the platform via respective communications links; wherein the communications receiver module receives, from a first interactive trading terminal, first digitized trading data which includes a first public price, and one or more better secret prices for a first side of a first order listed on the platform;
a communications transmitter module that transmits digitized trading data to all the interactive computer trading terminals via respective communications links, for display at the terminals; and
a communications management engine that interfaces between the communications receiver module and the communications transmitter module; wherein the communications management engine responds to the first digitized trading data by extracting the first public price, and by passing it to the communications transmitter module that transmits it to all the interactive computer trading terminals, where it is displayed in real time against the first side of the first order;
and wherein the communications management engine also extracts and records the one or more secret prices in a data store against a first side of the first order, but does not to pass them to the communications transmitter module, so that the one or more secret prices are not revealed to other traders;
and wherein the communications receiver module also receives further digitized trading data from a second interactive trading terminal, operated by a counter party to the first trader, and containing a second public price on a second side of the first order;
and wherein the communications management engine responds to the further digitized trading data by recognizing the second public price and passing it to the communications transmitter module that transmits it to all the interactive computer trading terminals where it is displayed in real time against a second side of the first order;
and wherein the communications management engine also responds to the further digitized trading data by comparing the second public price to the first public price, and by retrieving the recorded secret prices against a first side of the first order, from the data store and comparing them to the second public price, and by automatically responding to a second pubic price which matches a price in the first digitized trading data, whether public or secret, by facilitating a trade between the first and second parties for all or part of the first order at the matched price.

2. An interactive, automated computerized trading platform according to claim 1, wherein facilitating a trade between the first and second parties requires the communications management engine automatically notifying the first and second parties of the match by means of digitized messages transmitted over respective communications links.

3. An interactive, automated computerized trading platform according to claim 1, wherein the communications receiver module receives a notification price from third trader, and the communications management engine does not pass the notification price to the communications transmitter module, but responds automatically to a counterparty trader's public price which matches or overlaps the notification price, by notifying the third trader of the match or overlap.

4. An interactive, automated computerized trading platform according to claim 3, wherein the communications management engine automatically sets the notification price at a predetermined difference from a secret price previously specified by the third trader.

5. An interactive, automated trading platform according to claim 1, wherein the communications receiver module receives a secret price for a second listed order on the platform from fourth trader, and the communications management engine does not pass the secret price to the communications transmitter module, even though the fourth trader has no public price against the second order.

6. An interactive, automated computerized trading platform according to claim 5, wherein the communications management engine automatically either cancels a secret price, or converts a secret price into a notification price, leaving the rest of the digitized trading data intact, when a predetermined event occurs.

7. An interactive, automated trading platform according to claim 6, wherein the communications receiver module further receives a length of time for which the secret price stays firm from the fourth trader, and the predetermined event is the expiry of the length of time.

8. An interactive, automated computerized trading platform according to claim 1, wherein in the event the communications receiver module receives more than one price for the same order, on the same side and in the same amount, the communications management engine applies rules stored in a data store to determine which price is passed to the communications transmitter module for transmission to the counterparty first.

9. An interactive, automated computerized trading platform according to claim 1, wherein in the event the communications receiver module receives two prices on different sides of the same order, at least one of which prices is public, and the two prices overlap without matching, then communications management engine applies rules retrieved from a data store to determine how the overlap is resolved before passing a resolved price to the communications transmitter module for transmission to the counterparty.

10. An interactive, automated computerized trading platform according to claim 1, wherein the communications links are secure communications links.

11. A method of operating an interactive, automated computerized trading platform that regulates the buying and selling of all or part of orders listed on the platform by traders, comprising:
receiving first digitized trading data transmitted from a first one of a network of interactive computer trading terminals that are coupled with the platform via respective communications links;
wherein the first digitized trading data includes a first public price, and one or more better secret prices for a first side of a first order listed on the platform;
extracting the first public price from the first digitized trading data and compiling the first public price into second digitized trading data, but not compiling the secret prices into the second digitized trading data;
extracting the secret prices and storing them in a data store;
transmitting the second digitized trading data to all the interactive computerized trading terminals via respective communications links, where the first public price is displayed against the first side of the first order;
receiving third digitized trading data from a second interactive trading terminal, operated by a counter party to the first trader, and containing a second public price on a second side of the first order;
responding to the third digitized trading data by extracting the second public price and compiling it into fourth digitized trading data;
transmitting the fourth digitized trading data to all the interactive computer trading terminals where it is displayed in real time against a second side of the first order;
and responding to the fourth digitized trading data by comparing the second public price to the first public price, and by retrieving the recorded secret prices against a first side of the first order, from the data store and comparing them to the second public price;
and automatically responding to a second pubic price which matches a price in the first digitized trading data, whether public or secret, by facilitating a trade between the first and second parties for all or part of the first order at the matched price.

12. A computer program product for operating an interactive, automated computerized trading platform that regulates the buying and selling of all or part of orders listed on the platform by traders, the computer program product comprising a computer readable medium having computer readable program code stored thereon, the computer readable program code comprising program code for performing the method according to claim 11.
